(19) United States
(12) Patent Application Publication
(10) Pub. No.: US 2017/0225699 A1
(43) Pub. Date: Aug. 10, 2017

(54) Collapsible Cart Assembly

(71) Applicant: Cheryl Santelli, Sarasota, FL (US)

(72) Inventor: Cheryl Santelli, Sarasota, FL (US)

(21) Appl. No.: 15/040,785

(22) Filed: Feb. 10, 2016

(51) Int. Cl. B62B 3/02; B60N 3/10; B62B 5/00; B62B 5/06

(52) U.S. Cl. CPC B62B 3/027; B62B 5/06; B60N 3/10; B62B 5/002

(57) ABSTRACT

A collapsible cart assembly includes a cart that includes a frame and a box. The box is coupled to frame such the box may store items. The frame is positionable in an extended position such that the cart may contain and transport the items while shopping. The cart is positionable in a collapsed position such that the cart may be stored in a vehicle. A plurality of wheels is provided and each of the wheels is rotatably coupled to the cart such that each of the wheels may roll along a support surface. A handle is coupled to the cart such that the handle may be gripped. A plurality of hangers is provided and each of the hangers is attached to the cart such that each of the hangers may have an object suspended therefrom. A cup holder is attached to the cart.

### BACKGROUND OF THE DISCLOSURE

### Field of the Disclosure

The disclosure relates to cart devices and more particularly pertains to a new cart device to that may be collapsed thereby facilitating the cart to be stored in a vehicle.

SUMMARY OF THE DISCLOSURE

An embodiment of the disclosure meets the needs presented above by generally comprising a cart that includes a frame and a box. The box is coupled to frame such the box may store items. The frame is positionable in an extended position such that the cart may contain and transport the items while shopping. The cart is positionable in a collapsed position such that the cart may be stored in a vehicle. A plurality of wheels is provided and each of the wheels is rotatably coupled to the cart such that each of the wheels may roll along a support surface. A handle is coupled to the cart such that the handle may be gripped. A plurality of hangers is provided and each of the hangers is attached to the cart such that each of the hangers may have an object suspended therefrom. A cup holder is attached to the cart such that the cup holder may hold a container.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a collapsible cart assembly according to an embodiment of the disclosure.

FIG. 2 is a top view of an embodiment of the disclosure.

FIG. 3 is a right side view of an embodiment of the disclosure.

FIG. 4 is a left view of an embodiment of the disclosure in a collapsed position.

FIG. 5 is a bottom view of an embodiment of the disclosure.

FIG. 6 is a perspective in-use view of an embodiment of the disclosure.

### DESCRIPTION OF THE PREFERRED EMBODIMENT

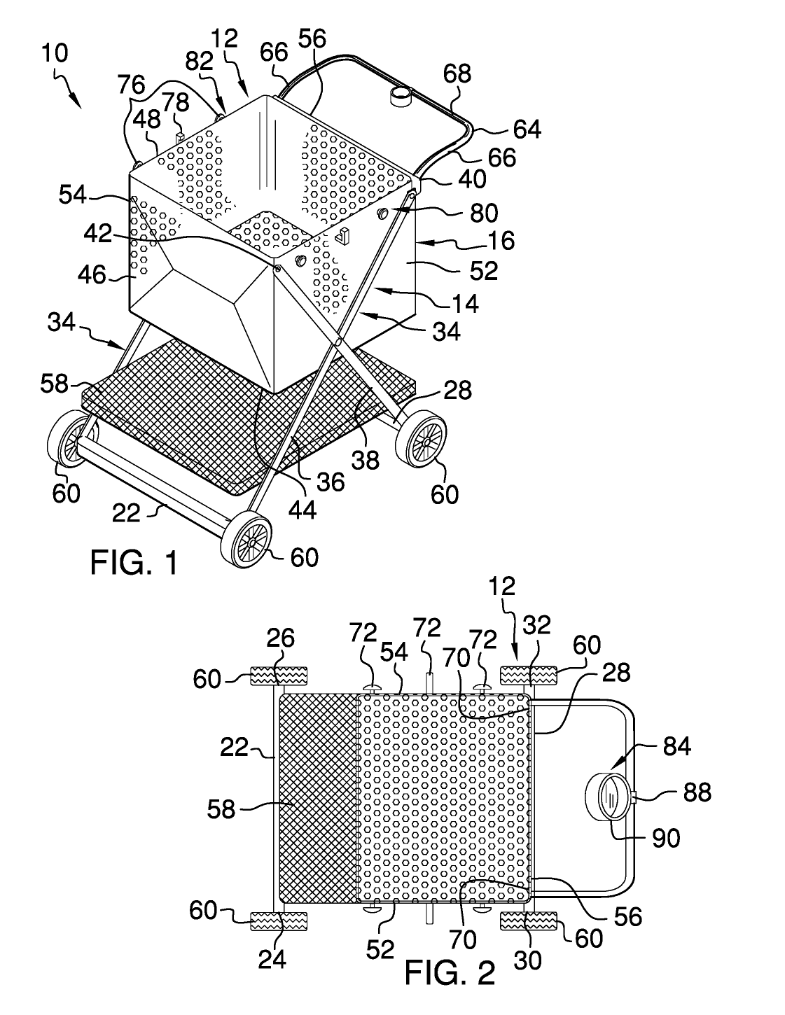

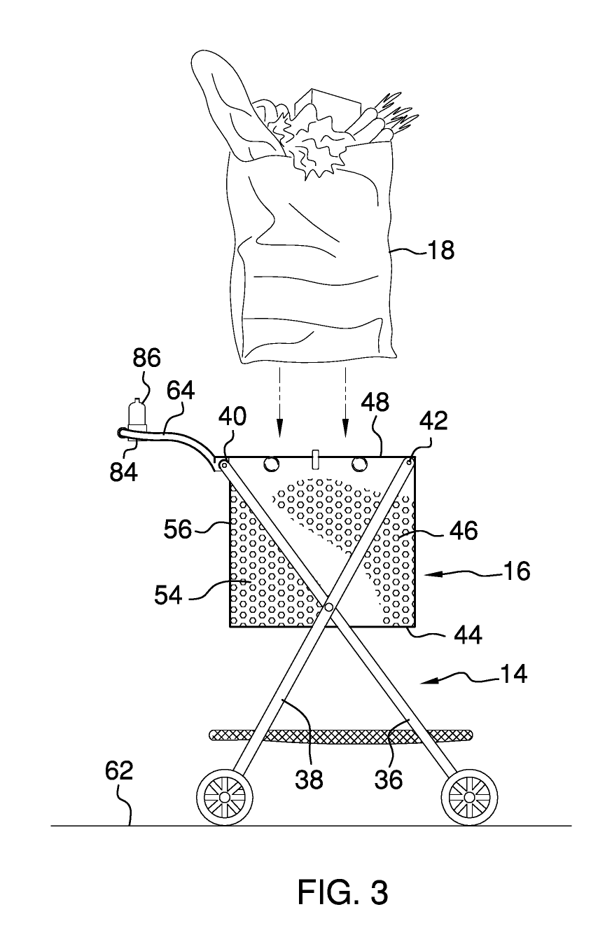

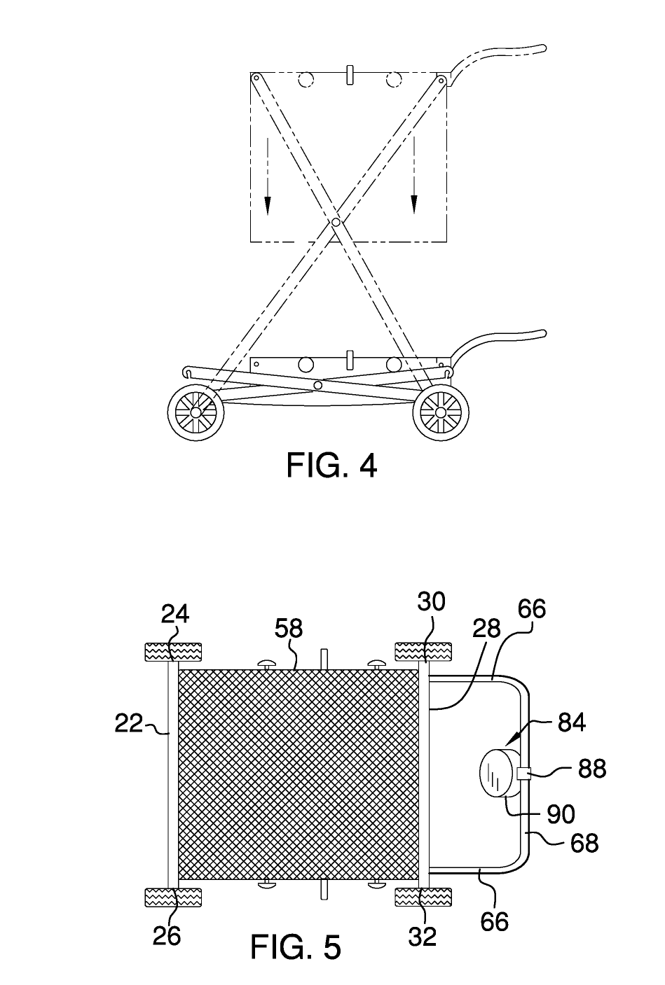

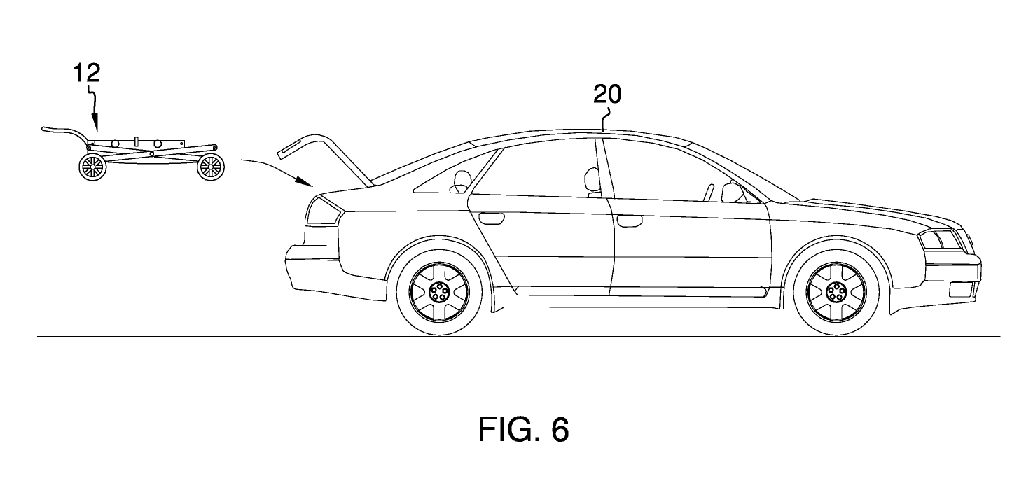

With reference now to the drawings, and in particular to FIGS. 1 through 6 thereof, a new cart device embodying the principles and concepts of an embodiment of the disclosure and generally designated by the reference numeral 10 will be described.

As best illustrated in FIGS. 1 through 6, the collapsible cart assembly 10 generally comprises a cart 12 that includes a frame 14 and a box 16. The box 16 is coupled to frame 14 such that the box 16 may store items 18 and the items 18 may be grocery bags or the like. The frame 14 is positionable in an extended position such that the cart 12 may contain and transport the items 18 and the items 18 may be purchased while shopping. The cart 12 is positionable in a collapsed position such that the cart 12 may be stored in a vehicle 20. The cart 12 may assist a disabled user in shopping or other activities involving the collection and transporting of multiple items 18.

The frame 14 includes a first axle 22 that has a first end 24 and a second end 26. The frame 14 further includes a second axle 28 that has a first end 30 and a second end 32. A pair of uprights 34 is provided and each of the uprights 34 is coupled between the first axle 22 and the second axle 28 such that the first axle 22 and the second axle 28 are spaced apart from each other. Each of the uprights 34 includes a first member 36 that is rotatably attached to a second member 38. The first member 36 of each of the uprights 34 is coupled to the first end 24,30 of an associated one of the first axle 22 and the second axle 28. The second member 38 of each of the uprights is coupled to the second end 26,32 of an associated one of the first axle 22 and the second axle 28.

The first member 36 of each of the uprights 34 has a distal end 40 with respect to the first axle 22 and the second member 38 of each of the uprights 34 has a distal end 42 with respect to the second axle 28. Each of the uprights 34 extends upwardly from the first axle 22 and the second axle 28 when each of the uprights 34 is positioned in the extended position such that each of the uprights 34 forms an X shape. Each of the uprights 34 extends laterally between the first axle 22 and the second axle 28 when each of the uprights 34 is positioned in the collapsed position.

The box 16 comprises a bottom wall 44 and a peripheral wall 46 extending upwardly from the bottom wall 44. The peripheral wall 46 has a distal edge 48 with respect to the bottom wall 44 and the distal edge 48 defines an opening into the box 16. The peripheral wall 46 has a first lateral side 52, a second lateral side 54 and a back side 56. The distal end 40,42 of each of the first member 36 and the second member 38 of one of the uprights 34 is rotatably coupled to the first lateral side 52. The distal end 40,42 of each of the first member 36 and the second member 38 of one of the uprights 34 is rotatably coupled to the second lateral side 54. The box 16 is comprised of a deformable material.

A platform 58 is provided and the platform 58 is attached between the pair of uprights 34. The platform 54 is positioned below the box 16. The platform 58 may support an object and the platform 58 may be comprised of a mesh material. A plurality of wheels 60 is provided and each of the wheels 60 is rotatably coupled to the cart 12 such that each of the wheels 60 may roll along a support surface 62. The support surface 62 may be ground. Each of the first end 24 and the second end 26 of the first axle 22 has one of the wheels 60 positioned thereon. Each of the first end 30 and the second end 32 of the second axle 28 has one of the wheels 60 positioned thereon.

A handle 64 is coupled to the cart 12 such that the handle 64 may be gripped. The handle 64 has a pair of first arms 66 that are each coupled to a central arm 68 and the first arms 66 are spaced apart from each other such that the handle 64 has a U shape. Each of the first arms 66 has a distal end 70 with respect to the central arm 68 and each of the first arms 66 is curved between the distal end 70 of each of the first arms 66 and the central arm 68. The distal end 70 of each of the first arms 66 is coupled to the back side 56 of the box 16.

A plurality of hangers 72 is provided and each of the hangers 72 is attached to the cart such that each of the hangers 72 may have an object 74 suspended therefrom. The object 74 may be a shopping bag or the like and the hangers 72 may comprise knobs 76 and hooks 78. The hangers 72 comprise a first set 80 of the hangers 72 and a second set 82 of the hangers 72. The first set of hangers 80 is positioned on the first lateral side 52 of the box 16 and the second set of hangers 82 is positioned on the second lateral side 54 of the box 16. Each of the hangers 72 is positioned adjacent to the distal edge 48 of the box 16.

A cup holder 84 is attached to the cart 12 such that the cup holder 84 may hold a container 86. The container 86 may be a can, a bottle, a glass or other container. The cup holder 84 has an arm portion 88 extending away from a cup portion 90. The arm portion 88 is attached to the central arm 68 of the handle 64 such that the cup portion 90 is positioned between the central arm 68 and the back side 56 of the box 16.

In use, the frame 14 is positioned in the extended position and the cart 12 is rolled along the support surface 62. The items 18 are placed within the box 16 and the cart 12 transports the items 18. The cart 12 is rolled to the vehicle 20 and the items 18 are loaded into the vehicle 20. The frame 14 is positioned in the collapsed position and the cart 12 is stored in the vehicle 20 when the items 18 are removed from the box 16.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A collapsible cart assembly configured to facilitate a disabled person to go shopping, said assembly comprising:
a cart comprising a frame and a box, said box being coupled to the frame wherein said box is configured to store items, said frame being positionable in an extended position wherein said cart is configured to contain and transport the items while shopping, said cart being positionable in a collapsed position wherein said cart is configured to be stored in a vehicle, said box including a bottom wall and a peripheral wall extending upwardly from said bottom wall, said peripheral wall having a distal edge with respect to said bottom wall, said distal edge defining an opening into said box, said peripheral wall having a first lateral side, a second lateral side and a back side;
a plurality of wheels, each of said wheels being rotatably coupled to said cart wherein each of said wheels is configured to roll along a support surface;
a handle being coupled to said cart wherein said handle is configured to be gripped;
a plurality of hangers, each of said hangers being attached to said cart wherein each of said hangers is configured to have an object suspended therefrom, each of said hangers being coupled to an outer face of said peripheral wall downwardly spaced from said distal edge with respect to said bottom wall of said box, said plurality of hangers including a first set of said hangers and a second set of said hangers, said first set of hangers being positioned on said first lateral side such that said first set of hangers is aligned along said first lateral side between an associated first pair of said wheels, said second set of hangers being positioned on said second lateral side such that said second set of hangers is aligned along said second lateral side between an associated second pair of said wheels, each of said hangers being positioned adjacent to said distal edge of said box; and
a cup holder being attached to said cart wherein said cup holder is configured to hold a container.

2. The assembly according to claim 1, wherein said frame comprises:
a first axle having a first end and a second end;
a second axle having a first end and a second end; and
a pair of uprights, each of said uprights being coupled between said first axle and said second axle such that said first axle and said second axle are spaced apart from each other.

3. The assembly according to claim 2, wherein each of said uprights includes:
a first member being rotatably attached to a second member, said first member of each of said uprights being coupled to said first end of an associated one of said first axle and said second axle, said second member of each of said uprights being coupled to said second end of an associated one of said first axle and said second axle; and
said first member of each of said uprights having a distal end with respect to said first axle, said second member of each of said uprights having a distal end with respect to said second axle.

4. The assembly according to claim 3, wherein each of said uprights extending upwardly from said first axle and said second axle when each of said uprights is positioned in said extended position such that each of said uprights forms an X shape, each of said uprights extending laterally between said first axle and said second axle when each of said uprights is positioned in said collapsed position.

5. (canceled)

6. The assembly according to claim 1, wherein:
said frame includes a pair of uprights, each of said uprights including a first member and a second member, each of said first member and said second member having a distal end; and
said distal end of each of said first member and said second member of an associated one of said uprights being rotatably coupled to said first lateral side, said distal end of each of said first member and said second member of an associated one of said uprights being rotatably coupled to said second lateral side, said box being comprised of a deformable material.

7. The assembly according to claim 2, wherein each of said first end and said second end of said first axle having one of said wheels being positioned thereon, each of said first end and said second end of said second axle having one of said wheels being positioned thereon.

8. The assembly according to claim 1, wherein:
said box has a back side; and
said handle has a pair of first arms each being coupled to a central arm, said first arms being spaced apart from each other such that said handle has a U shape, each of said first arms having a distal end with respect to said central arm, each of said first arms being curved between said distal end of each of said first arms and said central arm, said distal end of each of said first arms being coupled to said back side of said box.

9. (canceled)

10. The assembly according to claim 1, wherein:
said box has a back side;
said handle has a central arm; and
said cup holder has an arm extending away from a cup, said arm being attached to said central arm of said handle such that said cup is positioned between said central arm and said back side of said box.

11. A collapsible cart assembly configured to facilitate a disabled person to go shopping, said assembly comprising:
a cart comprising a frame and a box, said box being coupled to the frame wherein said box is configured to store items, said frame being positionable in an extended position wherein said cart is configured to contain and transport the items while shopping, said cart being positionable in a collapsed position wherein said cart is configured to be stored in a vehicle, said frame comprising:
a first axle having a first end and a second end,
a second axle having a first end and a second end, and
a pair of uprights, each of said uprights being coupled between said first axle and said second axle such that said first axle and said second axle are spaced apart from each other, each of said uprights including a first member being rotatably attached to a second member, said first member of each of said uprights being coupled to said first end of an associated one of said first axle and said second axle, said second member of each of said uprights being coupled to said second end of an associated one of said first axle and said second axle, said first member of each of said uprights having a distal end with respect to said first axle, said second member of each of said uprights having a distal end with respect to said second axle, each of said uprights extending upwardly from said first axle and said second axle when each of said uprights is positioned in said extended position such that each of said uprights forms an X shape, each of said uprights extending laterally between said first axle and said second axle when each of said uprights is positioned in said collapsed position;
said box comprising a bottom wall and a peripheral wall extending upwardly from said bottom wall, said peripheral wall having a distal edge with respect to said bottom wall, said distal edge defining an opening into said box, said peripheral wall having a first lateral side, a second lateral side and a back side, said distal end of each of said first member and said second member of an associated one of said uprights being rotatably coupled to said first lateral side, said distal end of each of said first member and said second member of an associated one of said uprights being rotatably coupled to said second lateral side, said box being comprised of a deformable material;
a plurality of wheels, each of said wheels being rotatably coupled to said cart wherein each of said wheels is configured to roll along a support surface, each of said first end and said second end of said first axle having one of said wheels being positioned thereon, each of said first end and said second end of said second axle having one of said wheels being positioned thereon;
a handle being coupled to said cart wherein said handle is configured to be gripped, said handle having a pair of first arms each being coupled to a central arm, said first arms being spaced apart from each other such that said handle has a U shape, each of said first arms having a distal end with respect to said central arm, each of said first arms being curved between said distal end of each of said first arms and said central arm, said distal end of each of said first arms being coupled to said back side of said box;
a plurality of hangers, each of said hangers being attached to said cart wherein each of said hangers is configured to have an object suspended therefrom, each of said hangers being coupled to an outer face of said peripheral wall downwardly spaced from said distal edge with respect to said bottom wall of said box, said plurality of hangers including a first set of said hangers and a second set of said hangers, said first set of hangers being positioned on said first lateral side such that said first set of hangers is aligned along said first lateral side between an associated first pair of said wheels, said second set of hangers being positioned on said second lateral side such that said second set of hangers is aligned along said second lateral side between an associated second pair of said wheels, each of said hangers being positioned adjacent to said distal edge of said box; and
a cup holder being attached to said cart wherein said cup holder is configured to hold a container, said cup holder having an arm extending away from a cup, said arm being attached to said central arm of said handle such that said cup is positioned between said central arm and said back side of said box.
